(19) United States
(12) Patent Application Publication
(10) Pub. No.: US 2020/0236947 A1
(43) Pub. Date: Jul. 30, 2020

(54) TREATING TURFGRASS FOR FUNGAL DISEASE

(71) Applicant: Steven R. Teerlink, Sandy, UT (US)

(72) Inventor: Steven R. Teerlink, Sandy, UT (US)

(21) Appl. No.: 16/776,876

(22) Filed: Jan. 30, 2020

Related U.S. Application Data
(60) Provisional application No. 62/798,733, filed on Jan. 30, 2019.

(51) Int. Cl. A01N 59/26; A01N 25/14; A01N 59/20; A01N 59/14

(52) U.S. Cl. CPC A01N 59/26; A01N 59/14; A01N 59/20; A01N 25/14

(57) ABSTRACT

The present disclosure is drawn to a method of treating turfgrass for fungal disease. The method can include applying an anti-fungal composition to soil covering plant roots of the turfgrass infected by a fungal disease at an average coverage density of about 0.0035 pound to about 0.0125 pound per square foot, wherein the anti-fungal composition comprises from about 15 wt % to about 40 wt % nitrogen content, as well as phosphorus and potassium. The method also includes watering the turfgrass on a daily basis starting at a time from about 5:30 PM to about 12 AM (midnight) and completing watering prior to about 12:30 AM the next morning (total watering window of time about 7 hours), wherein watering includes applying an average of 1/12 inch to ⅜ inch water to the turfgrass.

The present applicant claims the benefit of U.S. Provisional Patent Application No. 62/798,733, filed on Jan. 30, 2019, which is incorporated herein by reference in its entirety.

### BACKGROUND

In the field of agriculture and horticulture, control of plant pests such as harmful insects, fungi, and microorganisms, such as bacteria and viruses can be a struggle. Such controls can include sprays carrying traditional synthetic chemical pesticides, including chemical fungicides. Some sprays can be used without chemical pesticides, in which case the oil component of the spray can be used for interference with physical interactions of fungi or fungi spores at the host plant, e.g., leaves, roots, etc. For some applications, it can be desired to use sprays without added chemical pesticides or chemical fungicides. Such sprays are generally considered to be safer for humans, are less harmful to beneficial insects such as bees, and are more quickly degraded. One specific use for application of pesticides and/or fungicides relates to controlling turfgrass infections. Turfgrass generally includes any maintained grass surface, such as are typically used for lawns at homes, businesses, parks, golf courses, etc. Turfgrass has often been treated with synthetic chemical compounds to control pests, resulting in high maintenance costs and harmful effects to humans and the environment.

### DETAILED DESCRIPTION

The present disclosure relates to methods of treating or preventing fungal diseases that affect turfgrass, such as Necrotic Ring Spot for example. As used herein, “turfgrass” includes any type or variety of graminoid or graminoid-like plant. To avoid confusion, some types of turfgrass are sometimes conventionally referred to as “grass” or “lawn.” In one example, this treatment can be carried out without the use of a traditional fungicide. In accordance with this, a method of treating turfgrass for fungal disease can include applying an anti-fungal composition to soil covering plant roots of the turfgrass infected by a fungal disease at an average coverage density of about 0.0035 pound to about 0.0125 pound per square foot. The anti-fungal composition can include nitrogen (N) at from about 15 weight percent (wt %) to about 40 wt % nitrogen content, phosphorus (P), and potassium (K). The method can also include watering the turfgrass on a daily basis starting at a time from about 5:30 PM to about 12 AM midnight and completing watering prior to about 12:30 AM the next morning, wherein watering includes applying an average of 1/12 inch to ⅜ inch water to the turfgrass. In one more detailed example, the anti-fungal composition can include from about 1.8 wt % to about 8.8 wt % phosphorus content, and/or from about 4.1 wt % to about 16.6 wt % potassium content.

The anti-fungal composition can be in multiple forms and applied by a number of methodologies. For example, the anti-fungal composition can be in the form of dry anti-fungal particulates. In this form, the particulates can be spread using a standard lawn spreader device, such as a Scotts® Classic spreader or other spreader device. Hand held spreaders, or spreaders on wheels can be used that either drop the particulates, or laterally scatter the particulates therefrom.

In another example, the anti-fungal composition can be dissolved/dispersed in water to form an anti-fungal solution. In the form of a solution, the total amount of anti-fungal composition can be applied at a similar coverage density as the dry anti-fungal particulates, but being diluted in water, more volume can be applied to the turfgrass to put down the same coverage density of the anti-fungal composition. For example, the dry anti-fungal particulates can be dissolved/suspended in water at a 5 pound particulate to 3 gallon water ratio (about a 1:4 weight ratio). Other examples of solution ratios that can be prepared include dry anti-fungal particulate to water weight ratios of 1:2 to 1:7, from 1:3 to 1:6, or from 1:3 to 1:5.

In one example, watering can begin after the temperature drops below 80° F., and continues on from 75% to 100% of the subsequent watering days for good results, though this is not required. In another example, treating can be effective when the relative humidity (R.H.) at the hottest time of day on 75% to 100% of the watering days ranges from about 20% to about 50% R.H. (Again, after it begins to cool down in the evening, e.g., after about 6 PM). In another example, treating can be effective when the temperature at the hottest time of day on 75% to 100% of the watering days ranges from about 85° F. to about 105° F.

Treatment of turfgrass fungal disease, such as Necrotic Ring Spot, can be carried out in accordance with the present disclosure without the use of a traditional chemical fungicide, which can be environmentally friendly.

In some examples, the nitrogen content can be provided by urea, and additionally by a nitrogen source selected from ammoniacal nitrogen, a nitrate, or a combination thereof. In another example, the nitrogen content can be provided by ammonium nitrate, ammonium phosphate, potassium nitrate, urea, or a combination thereof. The phosphorus content can be provided by ammonium phosphate, potassium phosphate, or a combination thereof. The potassium content can be provided by potassium phosphate, potassium nitrate, potassium sulfate, or a combination thereof. For example, the potassium content can be provided by soluble potash. As used herein, “soluble potash” refers to various mined and manufactured salts that contain potassium in water-soluble form and is numerically expressed as a potassium oxide equivalent.

In addition to the nitrogen content, and in some cases the phosphorus and potassium content that can be present, other elements or supplemental minerals can also be included, such as boron, copper, iron, manganese, zinc, molybdenum, or a combination thereof. For example, the supplemental mineral can include a combination of three or more, four or more, five or more, or all six of the supplemental minerals, e.g., boron, copper, iron, manganese, zinc, or molybdenum. The anti-fungal composition can include, for example, from 0.005 wt % to 0.05 wt % boron content, from 0.01 wt % to 0.2 wt % copper content, from 0.05 wt % to 0.3 wt % iron content, from 0.01 wt % to 0.2 wt % manganese content, from 0.01 wt % to 0.2 wt % zinc content, and/or from 0.0001 wt % to 0.002 wt % molybdenum content, for example.

With this in mind, it is notable that as used herein, when referring to the anti-fungal compositions of the present disclosure that can be used to prevent and/or treat a turfgrass fungal infection, relative concentrations can be provided in some instances using the “N-P-K rating” system, which uses three numbers separated by two dashes commonly used in characterizing fertilizers. With the N-P-K rating system, the first number refers to the total elemental nitrogen (N) content (not the total concentration of the nitrogen source). The total nitrogen content can be provided by any of a number of sources. Additionally, P and K concentration values refer to phosphorus and potassium content, respectively. However, these values do not provide the actual elemental weight concentrations, but rather provide a conventional shorthand value for the amount of phosphorus (P) and potassium (K) that is present based on standard compounds. It is notable that those standard compounds may or may not be in the composition, but rather are used merely as a convention. For phosphorus (P), this number is referred to as “available phosphorus” value and is based on the standard compound P₂O₅ (where P makes up about 0.436 of the molar mass of the compound), whether or not P₂O₅ is present or not. For potassium (K), this number is referred to as “soluble potassium” and is based on the standard compound K₂O (where K makes up about 0.83 of the molar mass of the compound), whether or not K₂O is present or not. Thus, an N-P-K rating of 20-10-10, for example, means that in the fertilizer composition, there is i) 20 wt % of actual nitrogen (N), ii) the equivalent of phosphorus (P) that would be present in P₂O₅, e.g., about 4.36 wt % of phosphorus content, and iii) the equivalent amount of potassium (K) that would be available in K₂O, e.g., about 8.3 wt % of potassium content. As an example, a 15:30:15 composition or fertilizer would contain 15 wt % elemental nitrogen (N), 30 wt %×0.436=13.8 wt % elemental phosphorus (P), and 15 wt %×0.83=12.45 wt % elemental potassium (K). All other ingredients that are used are provided in actual weight percentages of the elemental content in the fertilizer, and can include other compounds as sources for the elemental content of sulfur (S), boron (B), copper (Cu), iron (Fe), manganese (Mn), molybdenum (Mo), zinc (Zn), etc.

When using the terms “phosphorus content” or “potassium content,” it is noted that this refers to the content (by weight percent) of the element phosphorus (P) or potassium (K), respectively that is present, excluding other elements that may be present in the compound. On the other hand, when referring to “available phosphorus” or “soluble potassium” in a formulation, this refers to the content (by weight percent) of phosphorus or potassium as defined using the N-P-K rating system defined above.

Application of the anti-fungal compositions of the present disclosure can be based on a “coverage density” of pounds per square foot, which can be converted easily to pounds per 1000 square feet (a convention often used in describing application of fertilizer to turfgrass for purposes of general grass fertilization). Pounds per square foot are used in this instance because when treating a turfgrass fungal infection such as Necrotic Ring Spot, for example, it may not be needed to apply 1000 square feet, and so to avoid confusion, a smaller unit of area coverage is used to make clear that the present anti-fungal compositions can be applied to either small areas or to large areas, depending on the circumstances.

In accordance with the present disclosure, it has been generally found that there are two methodologies that are practiced together to provide success in treating a turfgrass fungal disease, namely application of the anti-fungal composition (e.g., nitrogen content, presence of phosphorus and potassium, and coverage density) and watering profile (e.g., frequency, time of day, and amount of water applied). Both of these methodologies have specific parameters that can lead to success if practiced within certain range profiles, and surprisingly, deviation from these parameters may not be as effective, and in some cases can be counter-productive.

With specific reference to the application of the anti-fungal composition, the composition can be prepared to have a nitrogen content from 15 wt % to 40 wt %, and within this range, the coverage density on the turfgrass can be from 0.0035 pound to 0.0125 pound per square foot. Thus, regardless of whether it is applied as dry anti-fungal particulates or as a diluted anti-fungal solution, within this range of nitrogen content, the coverage density can provide the correct amount of nitrogen to the turfgrass. In further detail, in some examples, the anti-fungal composition can also include from about 1.8 wt % to about 8.8 wt % phosphorus content and from about 4.1 wt % to about 16.6 wt % potassium content. Thus fertilizers using the N-P-K rating system can have an “N” value from about 15 to about 40, a “P” value from about 5 to about 20, and a K value from about 5 to about 20. This range of combinations of N-P-K rating system values applied at the coverage densities described herein can be particularly effective. Example N-P-K fertilizer compositions that can be used include fertilizers rated 20-10-10, 40-20-10, 15-20-10, 30-10-10, 40-10-10, 40-15-5, 30-10-5, 34-10-10, 15-5-5, 40-20-20, etc., though any fertilizer within these N value ranges, P value ranges, and K value ranges can be used.

When the anti-fungal composition selected or prepared is correct for treating a turfgrass fungal disease, the average coverage density is the next element of application to consider. It has been found that an application coverage density of the anti-fungal composition, using the fertilizers described above, can be applied at a coverage density from 0.0035 pound to 0.0125 pound per square foot. In further detail, the coverage density can be from 0.0035 pound to 0.0110 pound, from 0.0045 pound to 0.0105 pound, from 0.005 pound to 0.0100 pound, from 0.0035 pound to 0.0075 pound, from 0.004 pound to 0.006 pound, from 0.0075 pound to 0.0125 pound, or from 0.0085 pound to 0.0115 pound per square foot. These ranges can be selected based on the severity of the fungal infection, the proximity to infected turfgrass, the climate conditions, or other factors. For example, with respect to Necrotic Ring Spot, treating the turfgrass can include causing a visibly-active Necrotic Ring Spot fungal infection to go dormant to allow the turfgrass to return to a condition where the visibly-active Necrotic Ring Spot is no longer visible. This can occur using an average coverage density of the anti-fungal composition that is about 0.0075 pound to about 0.0125 pound per square foot. Alternatively (or additionally to other areas of the turfgrass), treating can include preventing a visibly-active Necrotic Ring Spot fungal infection from spreading to other areas of turfgrass not affected by the Necrotic Ring Spot fungal infection, or can include preventing a Necrotic Ring Spot fungal infection from infecting a continuous area of turfgrass that is uninfected. This can occur at an average coverage density of the anti-fungal composition that is about 0.0035 pound to about 0.0075 pound per square foot. The term “visibly-active” indicates the presence of a fungus in the soil, at roots, and/or at blade-like leaves or turfgrass so that disease symptoms are visible upon inspection by a horticulturist or other expert on site, without the need for chemical or biological testing. For Necrotic Ring Spot, for example, there is a characteristic relatively large yellow ring that forms in otherwise greener turfgrass that would be apparent to a horticulturist, but also to a lawn care professional or even a lay person. Other fungi can be visibly-active or visibly apparent to an expert upon closer visual inspection of the soil, roots (upon pulling a few samples), or blade-like leaves, for example.

In one specific example, treating the turfgrass for a fungal infection, such as Necrotic Ring Spot, can include both causing a visibly active fungal infection to go dormant to allow the turfgrass to return to a condition where the visible fungal infection is no longer visible, and preventing a visibly-active fungal infection from spreading to other areas of turfgrass not affected by the Necrotic Ring Spot fungal infection, or preventing a new growth of Necrotic Ring Spot fungal infection from infecting other areas of the turfgrass not affected by the fungal infection. For example, causing the visibly-active fungal infection to go dormant is carried out at an average coverage density of the anti-fungal composition that is about 0.0075 pound to about 0.0125 pound per square foot at a site of the visibly-active fungal infection, e.g., Necrotic Ring Spot being visible with yellowed ring structures in the lawn, and preventing a visibly-active fungal infection from spreading to other areas of turfgrass is carried out at an average coverage density of the anti-fungal composition that is about 0.0035 pound to about 0.0075 pound per square foot, for example.

Regarding the application of the anti-fungal composition, this can be done one time followed by consistent watering as prescribed herein, or can be carried out on multiple occasions, e.g., once every two weeks for 2 to 6 applications, once every 30 days for 2 to 6 applications, once every 45 days for 2 to 6 applications, once every two weeks for 2 to 4 applications, once every 30 days for 2 to 4 applications, once every 30 days for 3 applications, etc.

The second component to consider is the watering profile. Specifically, it has been found that by watering at from about 6:00 PM and 12:00 AM (Midnight), e.g., within this 6 hour window starting no earlier than about 5:30 PM in the evening and finishing prior to 12:30 AM the next morning, the soil can receive moisture as the lawn begins to cool down from the hottest time in the day (usually 2-8 hours prior to watering). In some examples, water can be started and completed at from 6:00 PM to 12:00 AM (midnight), from 7:00 PM to 11:00 PM, from 7:00 PM to 10:00 PM, from 8:00 PM to 11:00 PM. In fact, it was found that by watering the turfgrass outside of this general watering window, using the anti-fungal composition described herein can in some cases encourage additional fungal growth at this coverage density and water application profile. It is believed that watering between 6 PM and 12 AM (midnight) may give the turfgrass lawn adequate time to dry before the heat of the day, as a wet lawn during the heat of the day can encourage the fungal growth.

Using an alternative metric other than time frame for watering, watering can begin when the ambient temperature is cooled or cooling from the hottest time of day in combination with at a time when the soil falls below about 80° F. in temperature. When the soil temperature is above about 80° F. and the anti-fungal composition of the present disclosure is applied to the soil, fungal growth can be encouraged, such as observed as being the case with Necrotic Ring Spot fungal disease. Thus, rather than a time schedule for beginning to water the turfgrass, a combination of falling daily temperatures and soil temperature can be used to know when to begin watering. Watering within 1 hour or within 2 hours of when the soil drops to a temperature below about 80° F. can provide appropriate water levels to the turfgrass while maximizing the time for water to be used before the next day when the soil is again heated to above about 80° F.

Furthermore, in this example, it has been found that by not watering every day, e.g., every other day, or every third day, etc., does not provide enough water to effectively treat or prevent the fungal infection, as validated by example in the treatment of Necrotic Ring Spot. Thus, too much water during the heat of the day, or too little water during the cool hours of the evening and night can both lead to increased fungal growth, whereas the right amount of watering at the right time of day (while the lawn is cooling for the evening early enough to dry before the heat of the day) can lead to excellent results in treating Necrotic Ring Spot when the anti-fungal composition of the present disclosure is applied to the turfgrass lawn as prescribed.

In further detail, once the anti-fungal composition is applied with the appropriate formulation, coverage density, watering profile, and sometimes multiple applications, results can start to be seen over a period of about 2 to 3 weeks, with more noticeable results being visible at about 30 to 60 days, depending on the severity of the fungal infection. For example, in the case of turfgrass with visible evidence of the Necrotic Ring Spot fungal infection, the yellow rings that are characteristic of this type of fungus can become deminimis, or the lawn can even appear to be healthy without visible yellow rings associated with this fungus.

With this in mind, it is noted that in many cases, the fungal spores are not necessarily killed, but rather using this protocol, can be forced into dormancy where the fungus cannot grow, but the spores may still remain. It has been found, for example, that excessive moisture when the soil is above about 80° F. can promote conditions for the fungus to grow and spread. Thus, the anti-fungal compositions (relative concentrations of nitrogen and the presence of phosphorus and potassium), average coverage density of the anti-fungal composition, and watering profile (time of day, frequency, and water application volume) can be used to prevent even live fungal spores from growing and/or spreading. Without continued watering using this watering profile, for example, the fungus can return. While the present methods can generally be used for treating turfgrass suffering from various fungal diseases, such as Fusarium, Pythium, Phytophthora, Verticillium, Rhizoctonia, Macrophomina, Thielaviopsis, Ophiosphaerella, and Scierotinas, in one aspect, the fungal disease can be Necrotic Ring Spot, Ophiosphaerella korrae, which is a soil borne fungi that mainly infects turfgrass roots.

It is noted that, as used in this specification and the appended claims, the singular forms “a,” “an,” and “the” include plural referents unless the context clearly dictates otherwise. In describing and claiming the teachings of the present disclosure, the following terminology will be used in accordance with the definitions set forth below.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 10 to about 50” should be interpreted to include not only the explicitly recited values of about 10 to about 50, but also include individual values and sub-ranges within the indicated range. Thus, included in this numerical range are individual values such as 20, 30, and 40 and sub-ranges such as from 10-30, from 20-40, and from 30-50, etc. This same principle applies to ranges reciting only one numerical value. Furthermore, such an interpretation should apply regardless of the breadth of the range or the characteristics being described.

### EXAMPLES

The following examples illustrate embodiments of the disclosure that are presently known. Thus, these examples should not be considered as limitations of the present disclosure, but are merely in place to teach how to make the useful compositions of the present disclosure based upon current experimental data.

### Example 1—Application of Dry Anti-Fungal Particulates to Treat and/or Prevent Turfgrass Infected with Necrotic Ring Spot

On a day in June where the temperature peaked about 90-95° F. with a relative humidity of about 20% to about 40%, in the evening (between 6:00 PM and 7:00 PM), a 30-10-10 dry anti-fungal particulate that included 30 wt % nitrogen content, 10 wt % available phosphate (4.36 wt % phosphorus content), and 10 wt % soluble potash (8.3 wt % potassium content) was applied as a dry anti-fungal particulate using a Scotts® Classic spreader (application setting #18) to the entirety of a large turfgrass lawn. The application coverage density of the dry anti-fungal particulate was 0.005 pound/foot² (pound/ft²), or 5 pounds/1000 ft².

To a smaller area of the turfgrass that was visibly affected by a Necrotic Ring Spot fungal infection, additional dry anti-fungal particulates were applied the same way at an additional coverage density 0.005 pound/ft², or 5 pounds/1000 ft², for a total of 0.01 pound/ft² applied only to the areas affected by the Necrotic Ring Spot fungal infection. The application to the turfgrass lawn in general and the additional application to the areas affected by the fungus can be carried out in any order.

After application, the 4,000 ft² turfgrass area, including the 500 ft² area of turfgrass affected by the Necrotic Ring Spot fungal infection, was then watered to achieve an average water coverage across the turfgrass lawn of about ⅛ to about ¼ inch prior to midnight, and every day thereafter within about a six hour window from about 6 PM and to about 12 AM (midnight). As a reference, ⅛ inch to ¼ inch of water can be achieved typically in 10-15 minutes per watering station using non-rotating sprinklers. Rotating Sprinklers can take from about 20-25 minutes per water station to achieve ⅛ inch to ¼ inch of water to the turfgrass lawn.

After several days of daily watering within this six (6) hour evening window, the Necrotic Ring Spot within the 500 ft² area was no longer visible and did not appear to spread to other areas of the turfgrass lawn.

By comparison, in similar turfgrass lawns with similar Necrotic Ring Spot fungal infections that were treated the same way with the exception of the watering profile, the application did not appear to be effective against the visible Necrotic Ring Spot. For example, rather than watering the lawn every day, when a turfgrass lawn was watered within the 6 hour watering window every other day (instead of every day), the Necrotic Ring Spot fungal infection remained, indicating that periodic watering beyond daily watering was not effective. In other experiments, when watering during the heat of the day, e.g., 2:00 PM, or early in the morning, e.g., 4 AM, it was found that the Necrotic Ring Spot was not diminished in size, but rather was encouraged to grow and even spread in some instances.

### Example 2—Preparation of Anti-Fungal Solution from Dry Anti-Fungal Particulates

An anti-fungal solution was prepared by admixing water with the dry anti-fungal particulates described in Example 1 at a ratio of 5 pounds of anti-fungal composition to 3 gallons of water ratio, e.g., 5 pounds to 3 gallons (w/v) ratio. A gallon of water weighs about 8.3 pounds, so the anti-microbial solution is about 20 wt % anti-fungal composition and about 80 wt % water, e.g., about 1:4 anti-microbial composition to water by weight. Thus, a bag with 25 pounds of the dry anti-fungal particulate anti-fungal composition mixes with 15 gallons of water to provide over 3 gallons of anti-fungal solution that can be applied to turfgrass using a sprayer or liquid applicator. If applied at a liquid application coverage density of about 3 gallons per 1000 ft², an equivalent amount of anti-fungal composition to the turfgrass can be applied as was applied in Example 1, e.g., about 0.005 pound/ft², or 5 pounds/1000 ft².

### Example 3—Application of Anti-Fungal Solution to Treat and/or Prevent Turfgrass Infected with Necrotic Ring Spot

On a day in June where the temperature peaked about 90-95° F. with a relative humidity of about 20% to about 40%, in the evening (between 6:00 PM and 7:00 PM), the anti-fungal solution prepared in accordance with Example 2 was applied to the entirety of a turfgrass lawn. The application coverage density of the dry anti-fungal particulates was 0.005 pound/foot², or 5 pounds/1000 ft², based on application of a little bit more than 3 gallons of the anti-fungal solution per 1000 ft² of turfgrass.

To a smaller area of the turfgrass that was visibly affected by a Necrotic Ring Spot fungal infection, additional anti-fungal solution was applied the same way, but to only the areas visibly impacted by Necrotic Ring Spot fungal infection, for a total of 0.01 pounds/ft² of anti-fungal composition (or 3+ gallons of anti-microbial solution per 1000 ft²) applied only to the areas affected by the Necrotic Ring Spot fungal infection. It is noted that the application to the turfgrass lawn in general and the additional application to the areas affected by the fungus can be carried out in any order.

After application, the entire turfgrass area, including the smaller area visibly affected by the Necrotic Ring Spot fungal infection, was then watered to achieve an average water coverage across the turfgrass lawn of about ⅛ to about ¼ inch prior to midnight, and every day thereafter within about a six hour window from about 6 PM and to about 12 AM (midnight). As a reference, ⅛ inch to ¼ inch of water can be achieved typically in 10-15 minutes per watering station using non-rotating sprinklers. Rotating Sprinklers can take from about 20-25 minutes per water station to achieve ⅛ inch to ¼ inch of water to the turfgrass lawn.

After several days of daily watering within this six (6) hour evening window, the Necrotic Ring Spot within the 500 ft² area was no longer visible and did not appear to spread to other areas of the turfgrass lawn.

By comparison, in similar turfgrass lawns with similar Necrotic Ring Spot fungal infections that were treated the same way with the exception of the watering profile, the application did not appear to be effective against the visible Necrotic Ring Spot. For example, rather than watering the lawn every day, when a turfgrass lawn was watered within the 6 hour watering window every other day (instead of every day), the Necrotic Ring Spot fungal infection remained, indicating that periodic watering beyond daily watering was not effective. In other experiments, when watering during the heat of the day, e.g., 2:00 PM, or early in the morning, e.g., 4 AM, it was found that the Necrotic Ring Spot was not diminished in size, but rather was encouraged to grow and even spread in some instances.

It is to be understood that the above-referenced arrangements are only illustrative of the application for the principles of the present disclosure. Numerous modifications and alternative arrangements can be devised without departing from the present disclosure. While the present disclosure has been described above with particularity and detail in connection with what is presently deemed to be the most practical embodiment(s) of the disclosure, it will be apparent that numerous modifications can be made without departing from the principles and concepts of the disclosure as set forth herein.

What is claimed is:

1. A method of treating turfgrass for fungal disease, comprising:
applying an anti-fungal composition to soil covering plant roots of the turfgrass infected by a fungal disease at an average coverage density of about 0.0035 pound to about 0.0125 pound per square foot, wherein the anti-fungal composition comprises nitrogen at about 15 wt % to about 40 wt % nitrogen content, phosphorus, and potassium; and
watering the turfgrass on a daily basis starting at a time from about 5:30 PM to about 12 AM midnight and completing watering prior to about 12:30 AM the next morning, wherein watering includes applying an average of 1/12 inch to ⅜ inch water to the turfgrass.

2. The method of claim 1, wherein the anti-fungal composition comprises about 1.8 wt % to about 8.8 wt % phosphorus content and about 4.1 wt % to about 16.6 wt % potassium content.

3. The method of claim 1, wherein treating includes causing a visibly-active fungal infection to go dormant to allow the turfgrass to return to a condition where the visibly-active is no longer visible.

4. The method of claim 3, wherein the average coverage density of the anti-fungal composition is about 0.0075 pound to about 0.0125 pound per square foot.

5. The method of claim 1, wherein treating includes preventing a visibly-active fungal infection from spreading to other areas of turfgrass not affected by the fungal infection, or wherein treating includes preventing the fungal infection from infecting a continuous area of turfgrass that is uninfected.

6. The method of claim 5, wherein the average coverage density of the anti-fungal composition is about 0.0035 pound to about 0.0075 pound per square foot.

7. The method of claim 1, wherein treating includes:
causing a visibly-active fungal infection to go dormant to allow the turfgrass to return to a condition where the visibly-active fungal infection is no longer visible, and
preventing a visibly-active fungal infection from spreading to other areas of turfgrass not affected by the fungal infection, or preventing a new growth of fungal infection from infecting other areas of the turfgrass not affected by the fungal infection.

8. The method of claim 7, wherein:
causing the visibly-active fungal infection to go dormant is carried out at an average coverage density of the anti-fungal composition is about 0.0075 pound to about 0.0125 pound per square foot at a site of the visibly-active fungal infection, and
preventing a visibly-active fungal infection from spreading to other areas of turfgrass is carried out at an average coverage density of the anti-fungal composition is about 0.0035 pound to about 0.0075 pound per square foot

9. The method of claim 1, wherein the anti-fungal composition is in the form of dry anti-fungal particulates and is applied as the dry anti-fungal particulates.

10. The method of claim 1, wherein the anti-fungal composition is admixed with water and applied in the form of an anti-fungal solution.

11. The method of claim 1, wherein the watering begins after the temperature drops below 80° F. on from 75% to 100% of the watering days.

12. The method of claim 1, wherein an ambient relative humidity where treating occurs at the hottest time of day on 75% to 100% of the days ranges from about 20% to about 50% R.H., and wherein a temperature where treating occurs at the hottest time of day on 75% to 100% of the days ranges from about 85° F. to about 105° F.

13. The method of claim 1, wherein the anti-fungal composition is applied without a chemical fungicide.

14. The method of claim 1, wherein the nitrogen content is provided by urea, and additionally by a nitrogen source is selected from ammonium nitrate, ammonium phosphate, potassium nitrate, ammoniacal nitrogen, or a combination thereof.

15. The method of claim 1, wherein the phosphorus content is provided by ammonium phosphate, potassium phosphate, or a combination thereof.

16. The method of claim 1, wherein the potassium content is provided by potassium phosphate, potassium nitrate, potassium sulfate, or a combination thereof.

17. The method of claim 1, wherein the potassium content is provided by soluble potash.

18. The method of claim 1, wherein the antifungal composition further comprises a supplemental mineral selected from boron, copper, iron, manganese, zinc, molybdenum, or a combination thereof.

19. The method of claim 18, wherein the supplemental mineral comprises a combination of three or more of boron, copper, iron, manganese, zinc, or molybdenum.

20. The method of claim 18, comprising from 0.005 wt % to 0.05 wt % boron content, from 0.01 wt % to 0.2 wt % copper content, from 0.05 wt % to 0.3 wt % iron content, from 0.01 wt % to 0.2 wt % manganese content, from 0.01 wt % to 0.2 wt % zinc content, from 0.0001 wt % to 0.002 wt % molybdenum content, or a combination thereof.
